(19) United States
(12) Patent Application Publication
(10) Pub. No.: US 2022/0085675 A1
(43) Pub. Date: Mar. 17, 2022

(54) ROTOR OF AN ELECTRIC MOTOR, AND ELECTRIC MOTOR

(71) Applicant: ebm-papst St. Georgen GmbH & Co. KG, St. Georgen (DE)

(72) Inventors: Michael KISCH, St. Georgen (DE); Jens LOEFFLER, Villingen-Schwenningen (DE); Jochen SCHEFFCZYK, Villingen-Schwenningen (DE); Bjoern WINTER, Breitnau (DE); Marcus HELLMANN, Unterkirnach (DE)

(21) Appl. No.: 17/420,469

(22) PCT Filed: Oct. 29, 2019
(86) PCT No.: PCT/EP2019/079547

§ 371 Date: Jul. 2, 2021

(30) Foreign Application Priority Data
Jan. 30, 2019 (DE) 10 2019 102 366.1

(51) Int. Cl. H02K 1/30; H02K 1/27; H02K 21/14

(52) U.S. Cl. CPC H02K 1/30; H02K 21/14; H02K 1/2733

(57) ABSTRACT

The disclosure relates to a rotor (1) and an electric motor having the rotor. The rotor is equipped with a permanent magnet (6) extending around an axis of rotation of the rotor, on which a plastic overmolding (3) is provided, which defines a shaft passage (10) for the fastening receptacle of a motor shaft (14) of the electric motor along the axis of rotation, and wherein a press-fit bushing (2), into which the motor shaft can be pressed by a press fit and can be fixed on the rotor, is arranged directly adjoining the shaft passage (10) formed by the plastic overmolding (3).

### FIELD

The disclosure relates to a rotor of an electric motor and an electric motor having a corresponding rotor.

### BACKGROUND

In electric motors having permanent magnets, a shaft-hub connection of the motor shaft on the magnets of the rotor is typically not implementable by a press fit, since the permanent magnet is formed from a brittle magnetic material, for example ferrite or ceramic.

### SUMMARY

The technical solution provided by example embodiments of the disclosure is to provide a rotor which is adapted in such a way that the motor shaft is fastenable via a press fit on the permanent magnet.

This technical solution is achieved by the combination of features according to claim 1, for example.

According to an example embodiment of the disclosure, a rotor of an electric motor having a permanent magnet extending around an axis of rotation of the rotor is proposed, on which a plastic overmolding is provided, which defines a shaft passage for the fastening receptacle of a motor shaft of the electric motor along the axis of rotation. A press-fit bushing, on which the motor shaft can be pressed in by a press fit and can be fixed on the rotor, is arranged directly adjoining the shaft passage formed by the plastic overmolding.

The motor shaft is thus not fastened on the rotor directly on the permanent magnet or its plastic overmolding, but indirectly via the press-fit bushing, which engages in the plastic overmolding. It is thus possible to use the brittle permanent magnet as a blank.

One advantageous embodiment of the rotor provides that the press-fit bushing and the permanent magnet are arranged at the same axial height along the axis of rotation and at least partially, preferably completely overlap viewed in axial section. The radial forces acting on the press-fit bushing during the pressing in of the motor shaft are thus supported on the permanent magnet. Forces which could cause jamming between the press-fit bushing and the permanent magnet are thus eliminated.

In one refinement of the rotor, it is moreover provided that the permanent magnet has at least one axial recess, in which the plastic overmolding engages in a formfitting manner, on at least one of its two axial end faces. However, the permanent magnet preferably has at least one axial recess, in which the plastic overmolding engages in a formfitting manner, on both of its axial end faces. The axial recess or the recesses provided on both sides are formed in one embodiment variant as a notch in the transition region from the axial end face to the radial inner lateral surface of the permanent magnet. An embodiment which is advantageous with respect to the force distribution in this case is that the recess or the recesses have a spherical cap cross section viewed in radial section. The plastic overmolding thus engages at the critical edge at the transition to the axial passage into the permanent magnet and prevents a relative movement between the permanent magnet and the plastic overmolding both during the pressing of the motor shaft and also in operation of the rotor.

Moreover, in one embodiment of the rotor, the plastic overmolding extends in the axial direction beyond the axial end faces of the permanent magnet and forms at least one contact surface on at least one of the two axial end faces of the permanent magnet. The contact surface also prevents an axial relative movement in a direction between the permanent magnet and the plastic overmolding, in particular during the pressing of the motor shaft, but also in operation of the rotor.

The rotor is furthermore characterized in one exemplary embodiment in that the plastic overmolding has an axial stop, which the press-fit bushing is positioned pressing against. The axial stop is preferably formed as a setback of the internal diameter of the inner lateral surface of the plastic overmolding, on which the press-fit bushing is supported in an axial direction. A misalignment of the press-fit bushing in the plastic overmolding and therefore in the rotor is thus prevented when the motor shaft is pressed into the press-fit bushing.

The permanent magnet is formed from brittle, elastic material, for example as a sintered ferrite magnet. In contrast, the plastic overmolding has partially elastic properties, so that the press-fit bushing can be pressed somewhat in the radial direction into the plastic overmolding. Depending on the design of the press fit between motor shaft and press-fit bushing, a certain radial expansion of the external diameter of the press-fit bushing into the plastic overmolding can be permitted as long as the required tensile and compressive stresses in the plastic overmolding are not exceeded.

Furthermore, an embodiment of the rotor is advantageous in which the press-fit bushing has an axial length which corresponds to at least 50%, preferably at least 60% of an axial length of the permanent magnet. Sufficient support between the press-fit bushing and the permanent magnet is thus ensured.

The rotor is preferably rotationally symmetrical, and the plastic overmolding and/or the permanent magnet are preferably integrally formed.

The disclosure moreover comprises an electric motor having a stator and an above-described rotor, in which the motor shaft is fixed on the rotor pressed into the press-fit bushing by a press fit.

### BRIEF DESCRIPTION OF THE DRAWINGS

Other advantageous refinements of the example embodiments of the disclosure are characterized in the dependent claims or are described in greater detail together with the description of the preferred embodiment of the disclosure on the basis of the figures. In the figures:

FIG. 1 shows a perspective sectional view of a rotor according to an example embodiment of the disclosure; and

FIG. 2 shows a lateral sectional view through an exemplary electric motor having a rotor according to FIG. 1.

### DETAILED DESCRIPTION OF EXAMPLE EMBODIMENTS

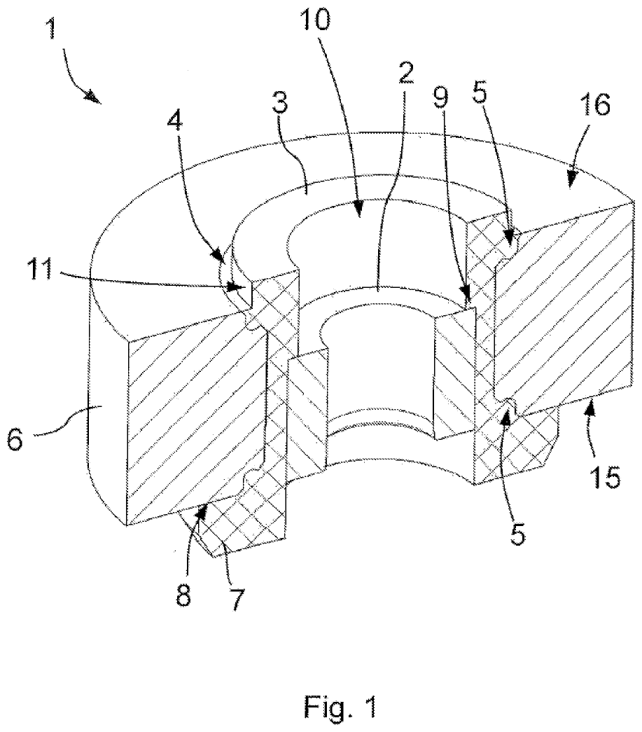

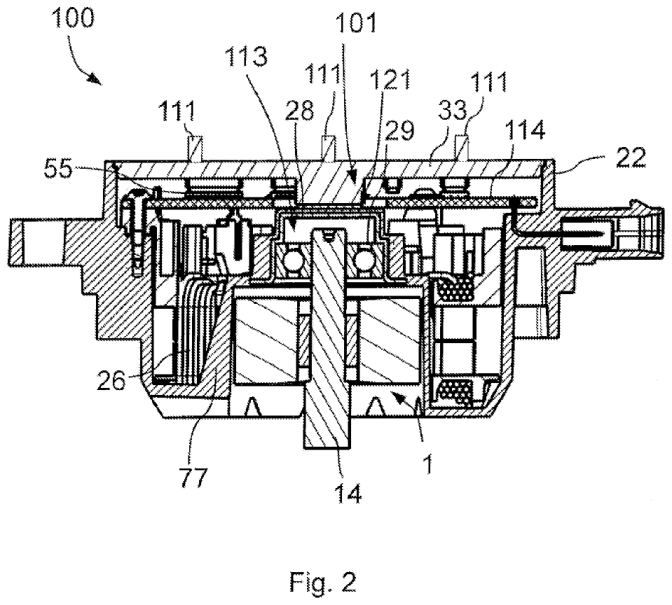

FIG. 1 shows an exemplary embodiment of a rotationally symmetrical rotor 1 in a perspective view. FIG. 2 schematically shows the rotor 1 from FIG. 1 in a state installed in an electric motor 100.

With reference to FIG. 1, the ring-shaped permanent magnet 6 extending around the axis of rotation of the rotor 1 includes the plastic overmolding 3 on its inner lateral surface, which defines the shaft passage 10 for the motor shaft 14, which is shown in FIG. 2, of the electric motor 100 along the axis of rotation. In the shaft passage 10, the press-fit bushing 2 is positioned essentially in the middle on the plastic overmolding 3, into which the motor shaft 14 is pressed for fastening on the rotor 1. The press-fit bushing 2 can expand radially outward into the partially elastic plastic overmolding 3, wherein the extent is restricted via the selection of the plastic material. In this case, thermal expansions, for example, due to heating of the bearing 29, are also taken into consideration. The plastic overmolding 3 has different internal diameters in the axial extension and forms a setback or step here, which is used as an axial step 9 for arranging the press-fit bushing 2 at an axially fixed point. Furthermore, the permanent magnet 6 extends beyond the press-fit bushing 2 on both sides, so that a complete overlap is provided and radial forces always act between the press-fit bushing 2 and the plastic overmolding 3 as well as the permanent magnet 6.

The integral plastic overmolding 3 forms a ring 11 protruding axially over the axial end face 16 on the first axial side of the permanent magnet 6, which merges into a radial expansion 4, which extends flush in an axial plane with the end face 16. On the second, opposing axial side of the permanent magnet 6, the plastic overmolding forms a radial projection 7, which provides the contact surface 8 on the axial end face 15 of the permanent magnet 6 and thus, for the pressing in of the motor shaft 14, blocks the relative movement of the permanent magnet 6 in relation to the plastic overmolding 3 in the same axial direction as the axial stop 9 for the arrangement of the press-fit bushing 2.

On the permanent magnets 6, which are formed integrally and circumferentially around the axis of rotation, a recess 5 formed as a circumferential notch is formed on each of the two axial end sides 15, 16 at the transition to the inner lateral surface, in which the plastic overmolding 3 engages in a formfitting manner. In the radial section shown according to FIG. 1, the cross sections of the notches are in the shape of spherical caps, since in this way the stresses are advantageously distributed. On the axial end face 16 of the permanent magnet 6, the radial expansion 4 of the plastic overmolding 3 extends beyond the radial length of the recess 5, on the opposing axial end face 15, the plastic overmolding 3 subsequently merges into the radial projection 7. The radial projection 7 is only provided axially on one side to save material.

The rotor 1 is installed, for example, in the electric motor 100 according to FIG. 2. In the electric motor 100, the motor shaft 14 is fixed on the rotor 1 by a press fit pressed into the press-fit bushing 2 and is mounted via the bearing 29. The electric motor 100 comprises an integral motor housing 22 having a housing cover 33, on the outside of which multiple cooling ribs are formed for better heat dissipation. On the side axially opposite to the housing cover 33, the motor housing 22 integrally forms a containment shell 77 extending axially into the interior of the motor housing 2. The motor section, in which the stator 66 and the motor electronics 55 fastened on the printed circuit board 114 are accommodated, is located between the inner wall of the motor housing 22 and the outer jacket of the containment shell 77. The shaft section in which the motor shaft 14 extends along its axis of rotation is located inside the containment shell 77 in a manner delimited sealed off via the containment shell 77. The containment shell 77 extends in axial direction essentially through the entire motor housing 22 up to the housing cover 33.

In the lowest section of the containment shell 77 viewed in the axial direction, a ball bearing cup 28 formed from a thermally conductive material, in particular from metal, is arranged. The motor housing 22 having the containment shell 77 is molded from plastic in the injection molding method around the ball bearing cup 28, so that the containment shell 77 and the ball bearing cup 28 have the same shape or inner and outer contour and press directly against one another. The ball bearing cup 28 defines the bearing seat for the pressed-in ball bearing 29, in which the motor shaft 14 is mounted. A free space 113, into which the motor shaft 14 extends with its free end, is formed between the ball bearing 29 and the axial inner wall surface of the containment shell 77.

A gap 121 having a gap dimension of at most 1/20 of the external diameter of the ball bearing is located axially between a cooling element 101 formed on the housing cover 33 and the axial outer wall surface of the containment shell 77. A layer of a thermally conductive paste, which is also replaceable by thermally conductive adhesive, is provided in the gap 121 in the embodiment shown.

Heat dissipation of the heat generated by the ball bearing 29 in operation takes place from the ball bearing 29 to the ball bearing cup 28, furthermore to the containment shell 77 and in the axial direction via the thermally conductive paste to the cooling element 101 of the housing cover 33 of the motor housing 22. The heat is emitted further to the external environment from the housing cover 33. The motor housing and in particular its housing cover 33 therefore function as a heat sink.

1. A rotor (1) of an electric motor having a permanent magnet (6) extending around an axis of rotation of the rotor, on which a plastic overmolding (3) is provided, which defines a shaft passage (10) for the fastening receptacle of a motor shaft (14) of the electric motor along the axis of rotation, and wherein a press-fit bushing (2), into which the motor shaft can be pressed by a press fit and can be fixed on the rotor, is arranged directly adjoining the shaft passage (10) formed by the plastic overmolding (3).

2. The rotor as claimed in claim 1, characterized in that the press-fit bushing (2) and the permanent magnet (6) are arranged at the same axial height along the axis of rotation and at least partially overlap viewed in axial section.

3. The rotor as claimed in claim 1, characterized in that the press-fit bushing (2) and the permanent magnet (6) are arranged at the same axial height along the axis of rotation and overlap completely over their respective axial length.

4. The rotor as claimed in claim 1, characterized in that the permanent magnet (6) includes at least one axial recess (5), in which the plastic overmolding (3) engages in a formfitting manner, on at least one of its two axial end sides (15, 16).

5. The rotor as claimed in claim 1, characterized in that the permanent magnet (6) includes at least one axial recess (5), in which the plastic overmolding (3) engages in a formfitting manner, on both of its axial end sides (15, 16).

6. The rotor as claimed in claim 4, characterized in that the axial recess (5) is formed as a notch in the transition region from the axial end side to the radial inner lateral surface of the permanent magnet (6).

7. The rotor as claimed in claim 4, characterized in that the recess (5) is formed circumferentially in the circumferential direction and has a spherical cap cross section.

8. The rotor as claimed in claim 1, characterized in that the plastic overmolding (3) extends in the axial direction beyond the axial end faces of the permanent magnet (6) and forms at least one contact surface on at least one of the two axial end faces of the permanent magnet (6).

9. The rotor as claimed in claim 1, characterized in that the plastic overmolding (3) includes an axial stop (9), which the press-fit bushing (2) is positioned pressing against.

10. The rotor as claimed in claim 1, characterized in that the permanent magnet (6) is formed from brittle, inelastic material.

11. The rotor as claimed claim 1, characterized in that the plastic overmolding (3) has partially elastic properties, so that the press-fit bushing (2) can be pressed in the radial direction into the plastic overmolding (3).

12. The rotor as claimed claim 1, characterized in that the press-fit bushing (2) has an axial length which corresponds to at least 50% of an axial length of the permanent magnet (6).

13. The rotor as claimed claim 1, characterized in that it is formed rotationally symmetrical.

14. The rotor as claimed in claim 1, characterized in that the plastic overmolding (3) and/or the permanent magnet (6) are integrally formed.

15. An electric motor (100) having a stator (26) and a rotor (1) as claimed in claim 1, wherein the motor shaft (14) is fixed on the rotor (1) pressed by a press fit into the press-fit bushing (2).
